(19) United States
(12) Patent Application Publication
(10) Pub. No.: US 2024/0399617 A1
(43) Pub. Date: Dec. 5, 2024

(54) METHOD OF COATING BUILDING INSULATION AND CLADDING SYSTEMS

(71) Applicant: Highland Park Technologies, LLC, Boston, MA (US)

(72) Inventors: Evan Smith, Roxbury, MA (US); Christian Borger, Boston, MA (US); Katherine Faulkner, Jamaica Plain, MA (US)

(21) Appl. No.: 18/800,763

(22) Filed: Aug. 12, 2024

Related U.S. Application Data
(63) Continuation-in-part of application No. 18/432,340, filed on Feb. 5, 2024.
(60) Provisional application No. 63/483,612, filed on Feb. 7, 2023.

(51) Int. Cl. B27N 7/00; B27N 3/04; E04F 13/08; E04F 13/16

(52) U.S. Cl. CPC B27N 7/005; B27N 3/04; E04F 13/165; E04F 13/0826; E04F 13/0889; E04F 2290/04

(57) ABSTRACT

Coating a bio insulated panel includes milling one or more surfaces of a non-coated bio insulated panel resulting in surface fibers, flame treating the milled panel surface to burn the surface fibers and heat the milled panel surface to dry the panel surface, and coating the milled panel surface while it is dry.

### RELATED APPLICATIONS

This application is a continuation-in-part of U.S. application Ser. No. 18/432,340 filed Feb. 5, 2024 and claims the benefit of and priority to U.S. application Ser. No. 18/432,340 filed Feb. 5, 2024 which itself claims the benefit of U.S. Provisional Application Ser. No. 63/483,612 filed Feb. 7, 2023, under 35 U.S.C. §§ 119, 120, 363, 365, and 37 C.F.R. § 1.55 and § 1.78, which are incorporated herein by this reference.

### FIELD OF THE INVENTION

Disclosed are aspects of a new building insulation and cladding system and methods.

### BACKGROUND OF THE INVENTION

There are many older energy inefficient buildings in existence. Retrofitting existing buildings to lessen their carbon footprint can offer a cost-effective solution for reducing energy consumption and carbon emissions. In some cases, building panels are installed onto the existing building. See published U.S. Application No. US2022/0049502 incorporated herein by this reference. Many such retrofitting systems and building wraps are difficult and time consuming to install and/or are expensive.

For a variety of reasons, bio insulated panels are desirable. Bio-based insulation is currently produced by a number of manufacturers and the materials utilized include wood, grass, hemp, mycelium, bamboo, recycled cellulose, and possible combinations thereof. In many cases, bio-based fibers are ground to a fine fluff, then mixed with binders which include urethane, paraffin, polyester, ethylene fiber, clay, and the like. Fiber and binders are typically cured under compression to create a rigid yet porous density that is dimensionally stable yet porous enough to maintain a high insulating value (U-factor or R-value).

### BRIEF SUMMARY OF THE INVENTION

At least the exterior surface of such panels should be coated to protect them from the elements. It is often also desirable to mill the exterior surface of such panels for aesthetic purposes. Milling and then coating such panels can be problematic. During the milling step, fibrous bio-based insulation products typically leave substantial loose surface fibers exposed. These loose surface fibers may affect the subsequent coating process and/or lead to a non-finished looking final product. Also, bio-based insulations have a natural moisture content regardless of the surrounding air humidity. Both the loose fibers and the moisture content cause issues for the application of two-part or heated coatings that are applied after milling to create a finished product.

Featured is an optimal combination of wood fiber insulation and a spray applied coating that is fire-resistant, impact resistant, highly weatherproof, and can be rapidly manufactured. The coatings will not delaminate from the substrate and survive temperature caused expansions/contractions as to not cause warping.

Featured is a method of coating a bio insulated panel. One or more surfaces of a non-coated bio insulated panel are milled resulting in surface fibers. The milled panel surface is flame treated to burn the surface fibers and heat the milled panel surface to dry the panel surface. The milled panel surface is coated while it is dry.

Milling may include sawing, drilling, and/or carving the panel. Flame treating may include using a flame at 2,000-2,500° F. Preferably, the flame treatment heats the milled surface to between 212 and 450° F.

The panel may be fed past the flame at a rate of 0.25-2 feet per second. The coating may include using a two-part coating. In one example, the coating is a polyurea coating.

The coating can be applied at a pressure of 1500-3000 psi and at a temperature of 50-400° F. Preferably, coating occurs in multiple passes along the milled panel. The first coating pass should occur within 30 minutes of flame treatment. Each pass usually results in a coating thickness of 5-15 mils. The coating passes continue until the coating thickness is preferably 20-80 mils.

The method may further include painting the coated milled surface of the bio insulated panel preferably before the coating fully cures to chemically integrate the paint into the coating.

The subject invention, however, in other embodiments, need not achieve all these objectives and the claims hereof should not be limited to structures or methods capable of achieving these objectives.

### BRIEF DESCRIPTION OF THE SEVERAL VIEWS OF THE DRAWINGS

Other objects, features and advantages will occur to those skilled in the art from the following description of a preferred embodiment and the accompanying drawings, in which:

FIGS. 1A-1B are schematic views showing a bio insulated panel outer surface being milled;

FIG. 2 shows flame treatment of the milled bio insulated panel exterior surface;

FIG. 3 shows coating the fire treated bio insulated panel exterior surface;

FIG. 4 shows the primary steps associated with a method of coating a bio insulated panel;

FIG. 5 is a schematic view showing two vertically adjacent building structures here in the form of panels installed on the building exterior;

FIG. 6 is a schematic exploded view of an exemplary building insulation and cladding system;

FIG. 7 is a schematic side view showing an example of the various components of a building insulation and cladding system in accordance with an example;

FIGS. 8A-8C are schematic isometric views of various types of clips;

FIGS. 9A-9F are schematic views showing the assembly of a subframe joint;

FIGS. 10A-10D are schematic views showing how the clips can be coupled to the subframe; and

FIGS. 11A-11F are schematic views showing a method of insulating and cladding an existing building exterior.

### DETAILED DESCRIPTION OF THE INVENTION

Aside from the preferred embodiment or embodiments disclosed below, this invention is capable of other embodiments and of being practiced or being carried out in various ways. Thus, it is to be understood that the invention is not limited in its application to the details of construction and the arrangements of components set forth in the following description or illustrated in the drawings. If only one embodiment is described herein, the claims hereof are not to be limited to that embodiment. Moreover, the claims hereof are not to be read restrictively unless there is clear and convincing evidence manifesting a certain exclusion, restriction, or disclaimer.

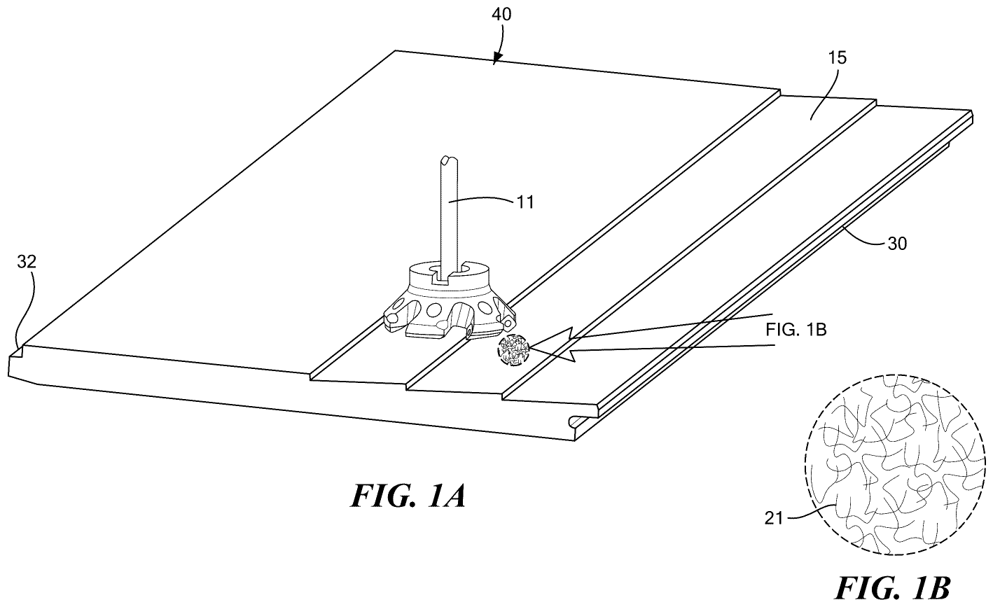

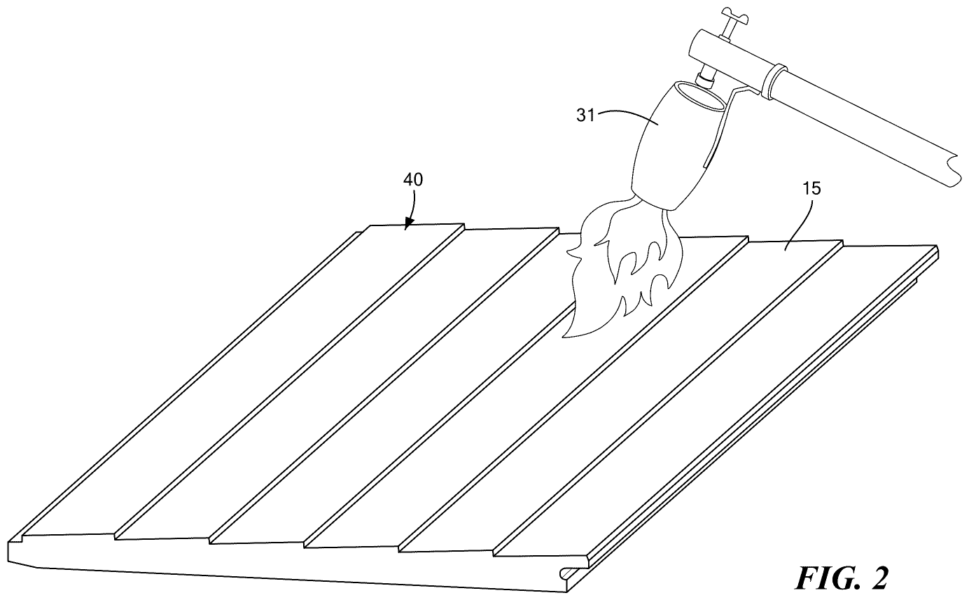

In one preferred embodiment, coating a bio insulated panel 40, FIG. 1, includes a milling operation as shown at 11 to provide an exterior surface 15 which mimics siding or other ornamentation as well as upper 32 and/or lower edges 30 for interlocking adjacent panels together as explained infra.

Milling is typically performed from a raw materials billet. The panel is milled from an insulation billet larger than the end product by a combination of sawing, drilling, and/or CNC-based carving methods. The right combination of mill speeds and tooling can be important. Too fast of mill speeds can result in the combustion of the insulation material. Too slow of a milling speed can result in the surface ending up rough and irregular.

These milling operations likely produce loose surface fibers 21 which need to be removed for a neat appearance before the coating is applied. Also, the loose surface fibers exposed after milling and the milled surface itself can have a moisture content which causes issues for the application of a two-part or heated coating applied after the milling operation to create a finished bio insulated panel.

Flame treating the milled panel surface 15, FIG. 2 as shown at 31 accomplishes two functions at once: 1) it burns off the surface fibers and 2) heats the milled panel surface to remove moisture. A properly gauged open flame flash burns the loose fiber fuzz and at the same time flash heats the surface to drive off any excess moisture content. In one example, an open flame array on a gantry can be used with propane or natural gas as the fuel. A typical flame temperature is in the 2,000-2,500° F. range and the panel can be fed through the flame array at a feed rate of around 1 foot per second. This burns off any loose fuzz but does not result in igniting the main mass of bio-based insulation. The flame treatment also causes the top panel surface to reach above 212° F. causing any moisture content in the surface to vaporize. Removing loose fibers and moisture properly prepares the surface of the panel for coating and consolidates the surface.

In some examples, the panel is fed by the flame at a rate of 0.25-2 feet per second. And, the flame treatment heats the milled surface to between 212 and 450° F.

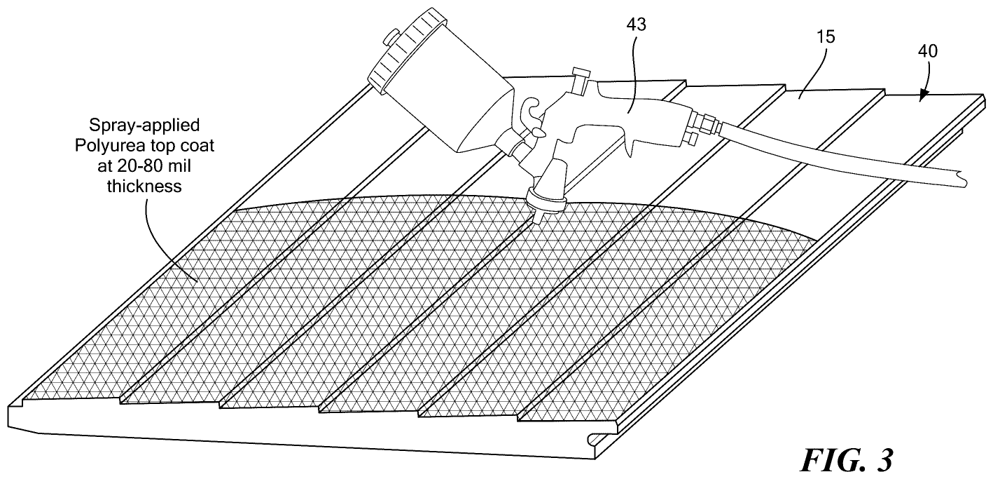

As shown in FIG. 3, the milled, flame treated panel surface is coated as shown at 43 with coating 42 while it is still dry and before it is able to reabsorb substantial moisture to the extent it adversely affects the application of the coating (e.g., fowling or blistering of the coating and/or a loss of adhesion of the coating to the surface). The coating can include epoxies, polyurea, polyurethane, and some two-part water-based products. Two-part composites have shown to work best especially those that can cure in a matter of seconds. Longer cure times have shown to soak into the surface and not create a proper sealed surface. A two-part catalyzing polyurea coating is preferably applied at a high pressure and moderate temperatures. This coating is applied almost immediately after the surface preparation flame treatment process so that the bio-based insulation is still dry and not left for any significant amount of time where it would reabsorb substantial moisture from the surrounding air. If the first layer of the coating is applied within 60 minutes of the flame treatment, excess moisture is not reabsorbed. The coatings can be sprayed utilizing a high pressure heated spray system. The two-part polyurea coating can be applied at 1,500-3,000 psi and at 50-400° F. with a final thickness of around 20-80 mils depending on the desired finish specifications. The two-part polyurea includes an integrated fire-retardant capability that can provide the coating with a Class A fire rating. The two-part polyurea also adds substantial impact resistance creating a durable surface. The spray coating can be applied in multiple thin coats to prevent fibers and bubbling being worked into the finished surface. In some examples, the coating is applied to a thickness of 5-15 mils (e.g., 10 mils), per coating pass until the ideal thickness of 40-50 mils is achieved. Thus, it is preferred that the coating occurs in multiple passes across the milled fire treated panel surface with each pass resulting in in a coating thickness of 20-80 mils.

A finished color coat of acrylic or solvent-based paint can be applied to the polyurea surface once the polyurea coating sets but does not fully cure. If the paint is applied while the polyurea surface is still chemically and physically “open” (typically within 0-4 hours of the initial set), the finished paint coat is chemically integrated into the base polyurea coat creating a permanent bond. With this finished coat, any color or pattern can be applied.

This method results in a bio insulated panel core surrounded by a solid and durable coating. Molding or hot forming operations are typically not required and yet a fully customizable surface texture is possible. Furthermore, the method results in excellent adhesion between the coating and the milled surface and excellent adhesion between the paint and the coating.

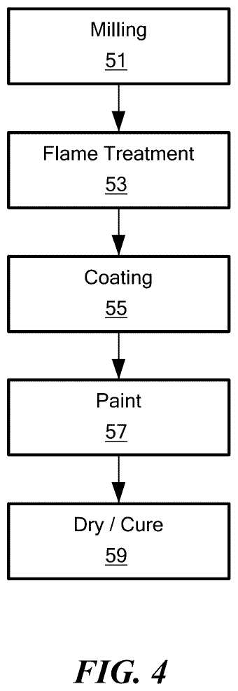

And, this method lends itself to automation as shown in FIG. 4 where the milling 51, flame treatment 53, coating 55, painting 57, and any necessary drying and/or curing processes 59 are wholly or partially automated using conveyors or the like which move the panels into and out of the various processing stations. In the flame treatment station, for example, a linear array of flame producing nozzles is positioned. In the coating station, a linear array of coating nozzles can be used.

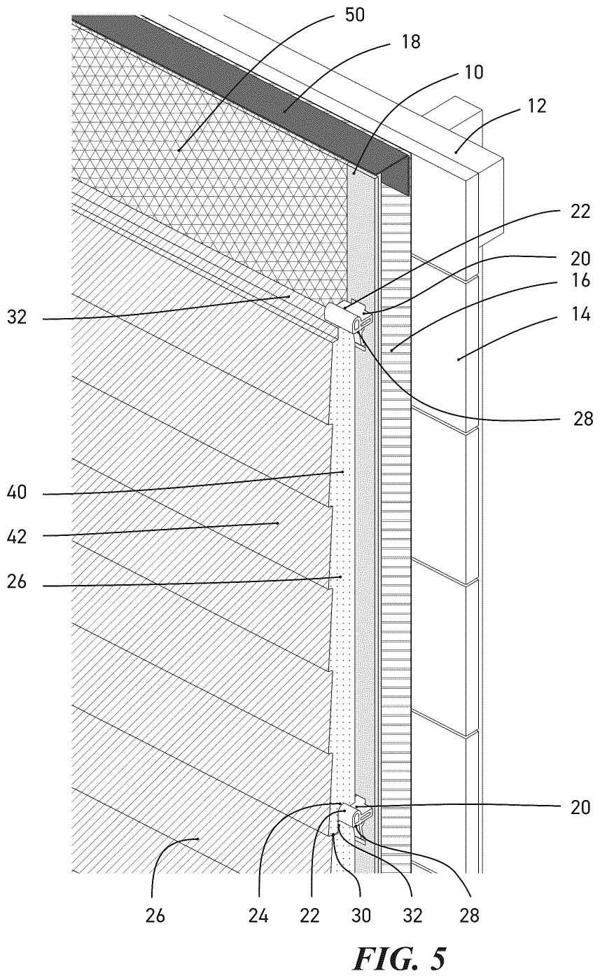

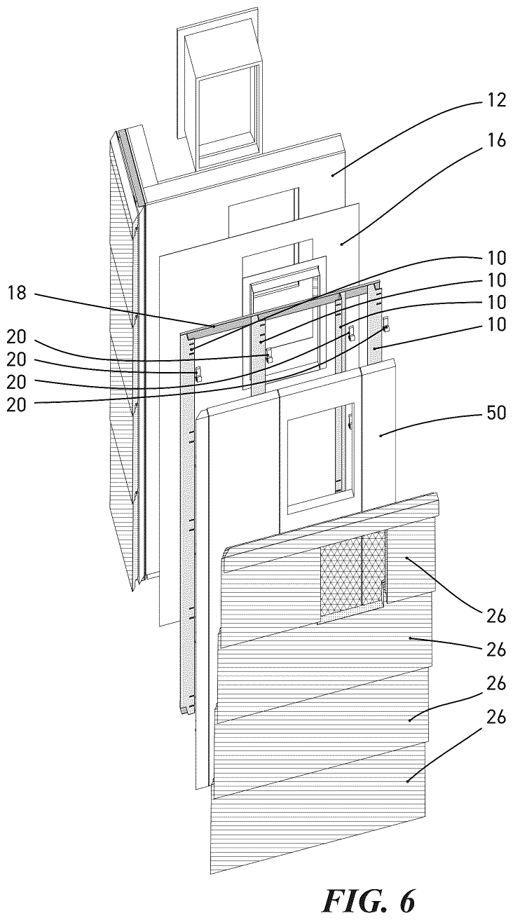

In one example shown in FIGS. 5-6, the building insulation and cladding system includes a plurality of spaced vertically extending tracks 10 (for example a Z-girt shaped track). Securable to the building exterior which may include building wall 12 with existing sheathing 14 covered with a vapor permeable membrane 16 (e.g., an adaptive weather resistant barrier (AWRB)) and/or additional insulation and/or other waterproof layers. Tracks 10 can be secured to the building exterior using fasteners. Tracks 10 can be assembled together as a subframe including L-angle top member 18 and a similar bottom L-angle member (not shown in FIG. 1) and the subframe then fastened to the building exterior. Other subframe combinations are possible.

Then, clips 20 (e.g. made of plastic) are fitted to the tracks. Preferably, each clip 20 includes a top rail 22 which is received in a lower edge groove 24 of a building structure 26 to support the building structure on top of a row of clips.

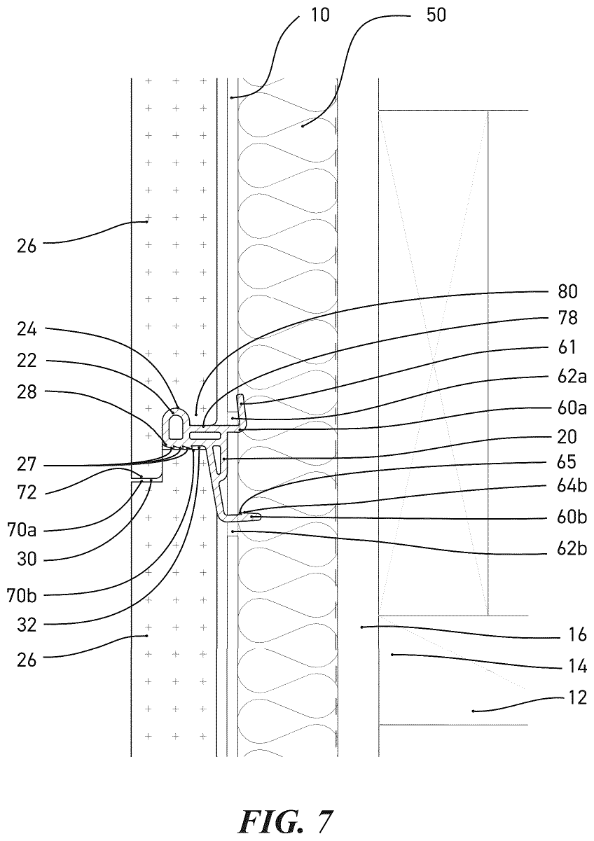

Also, the clips preferably include means such as a lower gripping surface with teeth 27 (FIG. 7) 28 configured to allow the top edge 32 of a lower building structure 26 in FIG. 5 to snap fit underneath clip 20 and is thus held in place by teeth 27 at least while the next building structure in FIG. 5 is installed on the top of the spaced clips. Thereafter, outer lower edge 30 of each building structure in FIG. 5 prevents the top edge 32 of the lower building structure in FIG. 5 from pivoting outwardly. Preferred building structures include bio insulated materials as discussed above.

The building structures can be in the form of panels as shown in FIG. 5 and/or configured around windows, doors, and the like as shown in FIG. 6. The building structures may include an insulation core 40, FIG. 5 and outer coating 42 produced as explained prior. The building structures may also include other insulation components 50, FIG. 6 pre-configured as a set for a given building layout. In one example, the building structures include a wood fiber or hemp wool insulation core. Coating 42 may be an epoxy.

As shown in FIG. 7, additional insulation and/or protective layers can be used in the system such as mineral wool insulation 50 behind building structure panels 26. Breather and/or water-resistant layers can also be used.

FIG. 7 also shows how clip 20 includes spaced rearwardly extending upper tab 60a and lower tab 60b which are received in spaced slots 62a, 62b in track 10. Tab 60b may include a spring finger 64b as shown which flexes into slot 62b and springs upward so barb 65 catches the track 10. Tab 60a includes upwards extension 61 held against the back side of track 10.

In one preferred version as shown in FIG. 7, each building structure 26 includes a top edge profile with first (70a) and second (70b) ascending steps and a bottom edge profile with outer lower edge 72 to be seated on or near the tread of first step 70a of the lower building structure. Preferably, the tread of step 70b engages the underside of the clip allowing the top edge of each building structure to snap fit underneath a set of clips. In some versions, the tread of step 70a of the lowermost building structure 26 in FIG. 7 supports outer lower edge 72 of the next upper adjacent building structure 26 in FIG. 7. In other versions, there is a space between step 70a and outer lower edge 72 which can be sealed by a gasket if desired.

Also, preferably, each clip 20 further includes top shelf 78 inward of rail 22 and each building structure 26 includes inner lower edge 80 which may seat on clip shelf 78. In other examples, the building structure is supported only by the clip rail.

FIG. 7 also shows how clip rail 22 seats in panel 26 lower edge groove 24.

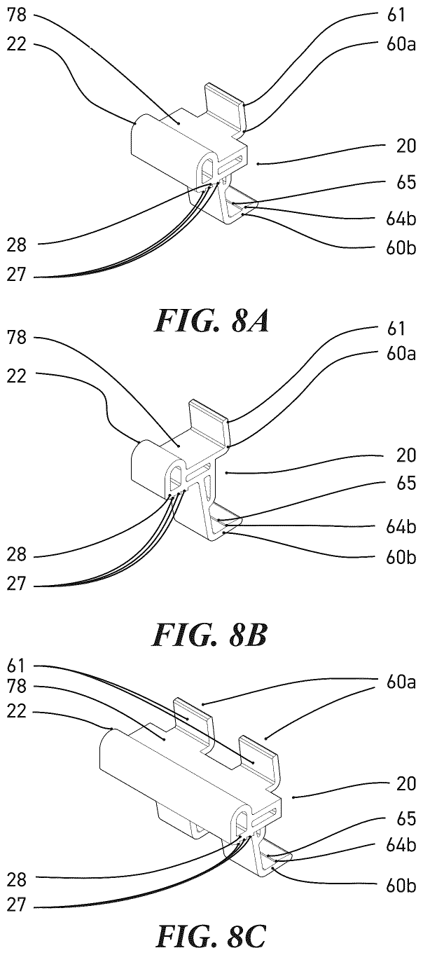

FIG. 8A depicts the structure of a long panel clip 20 while FIG. 8B shows a typical short version and FIG. 8C shows a panel clip that also joins two adjacent vertical tracks.

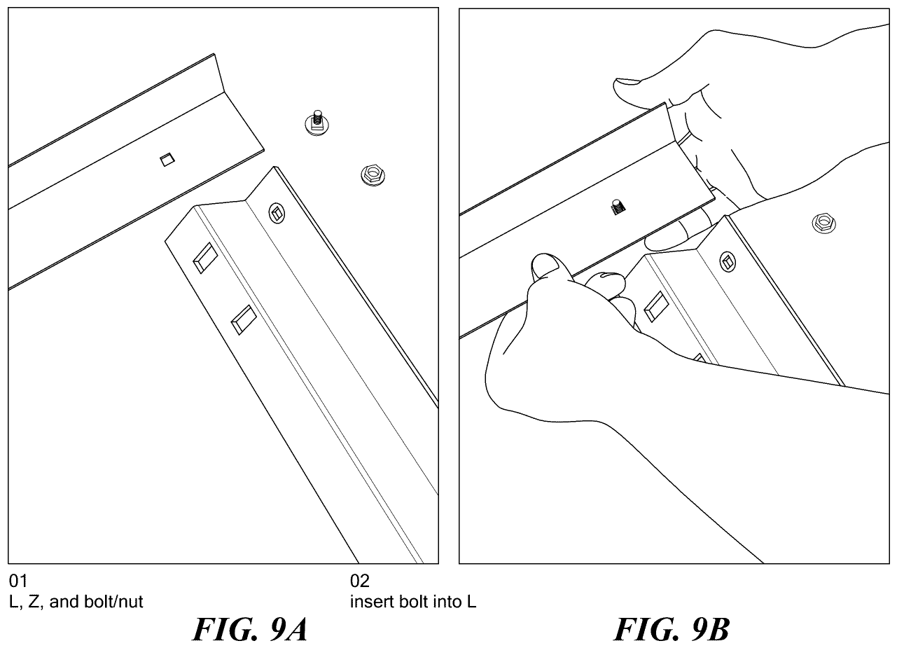

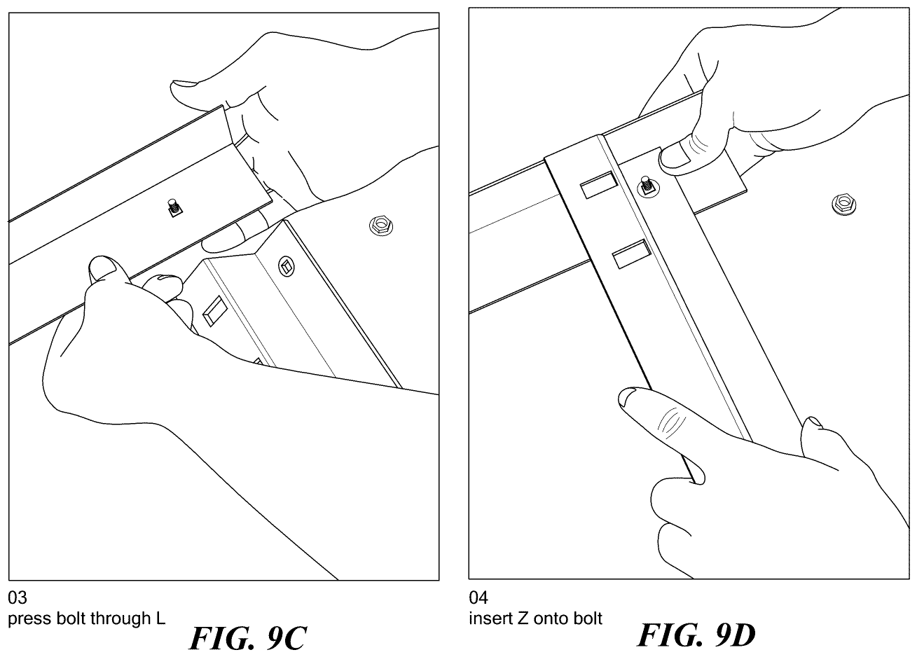

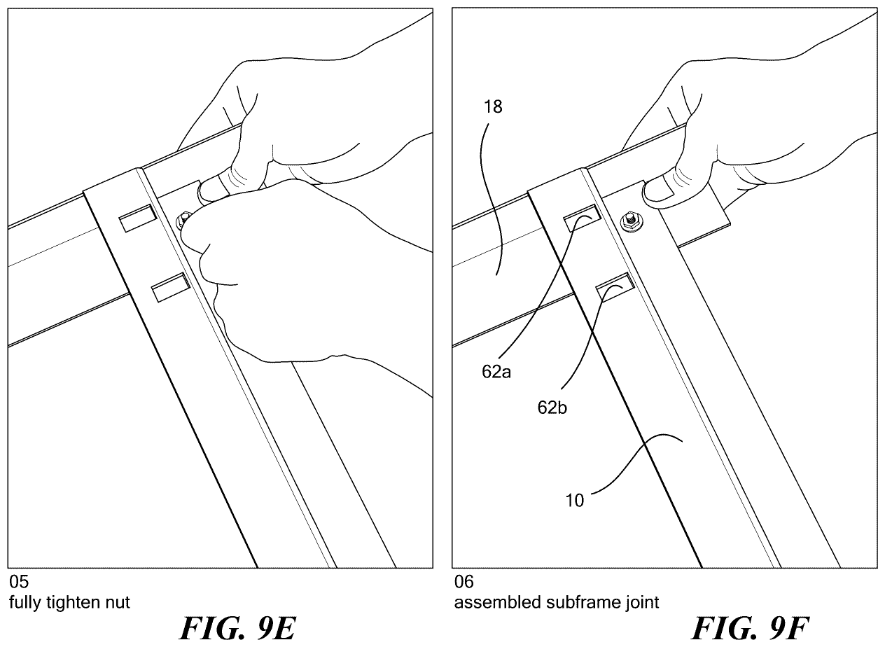

In FIGS. 9A-9F, vertical track 10 is fastened to L-angle member 18 in order to assemble a subframe joint.

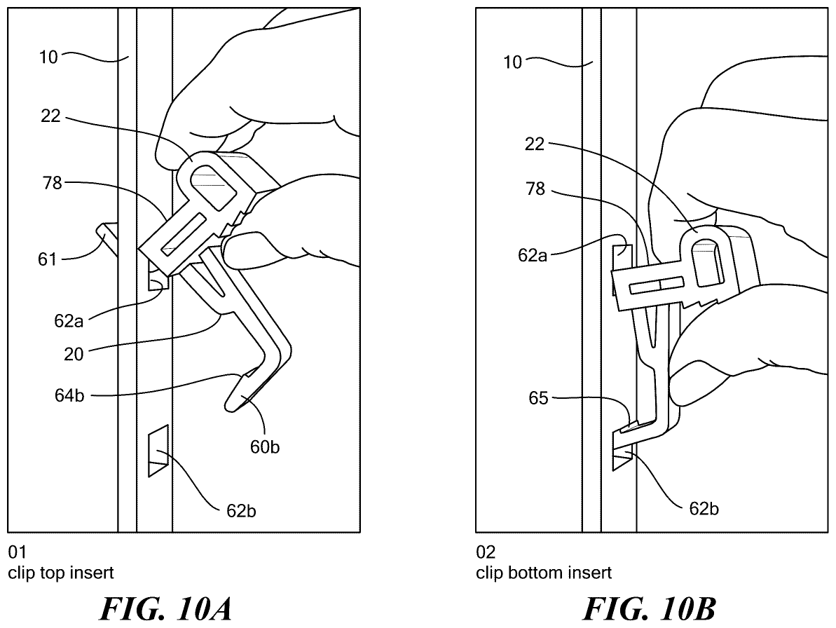

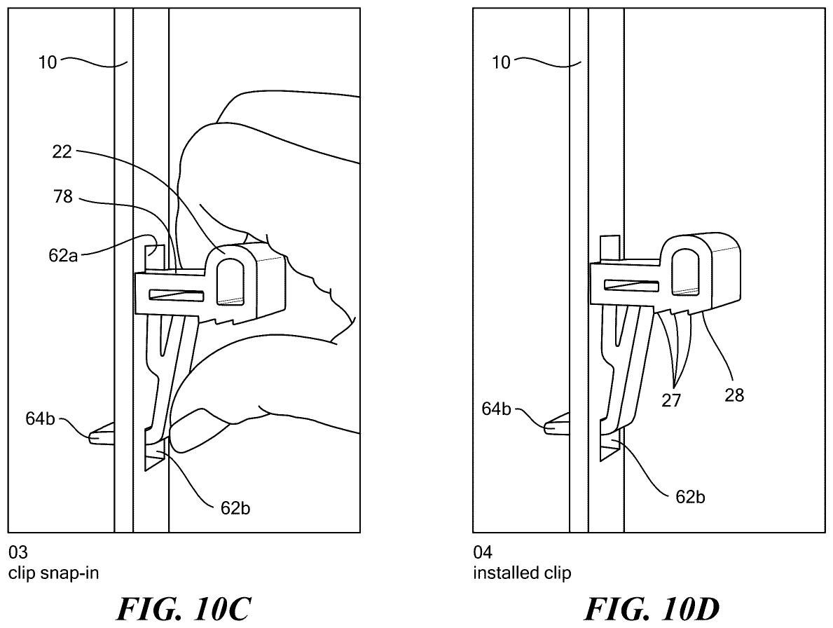

In FIGS. 10A-10D, a clip is shown being inserted and mated with a vertical track.

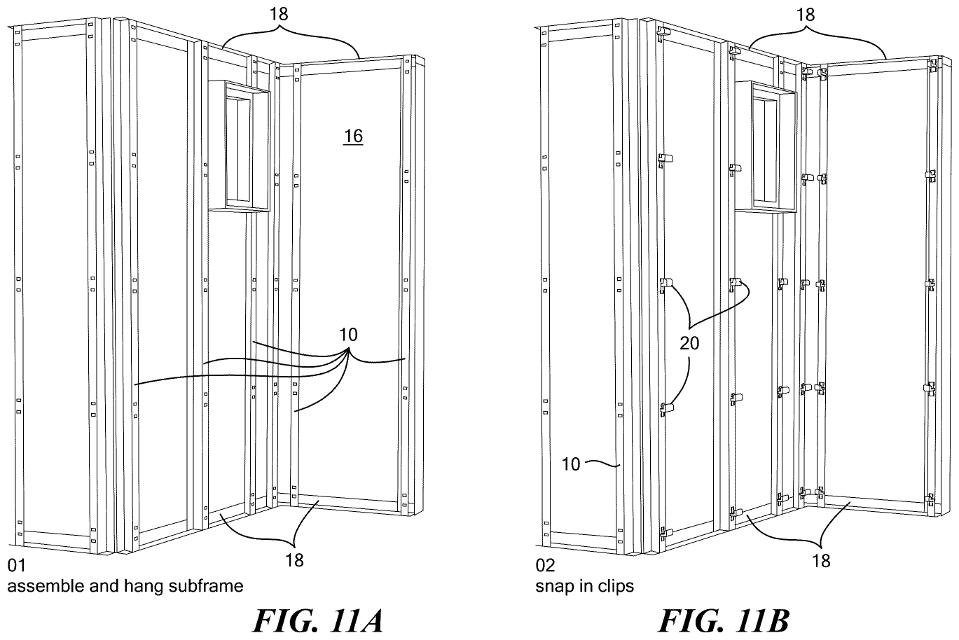

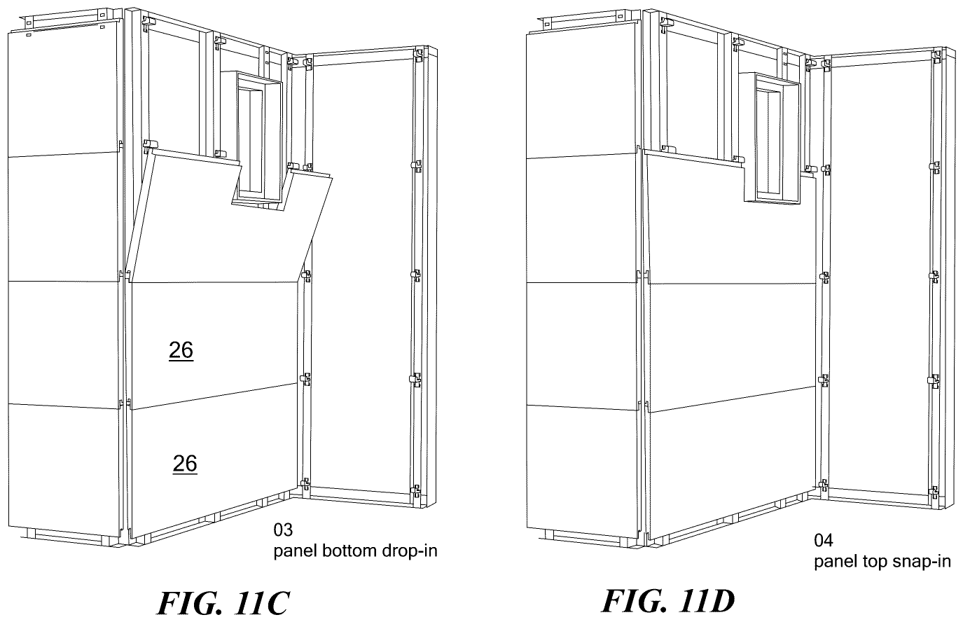

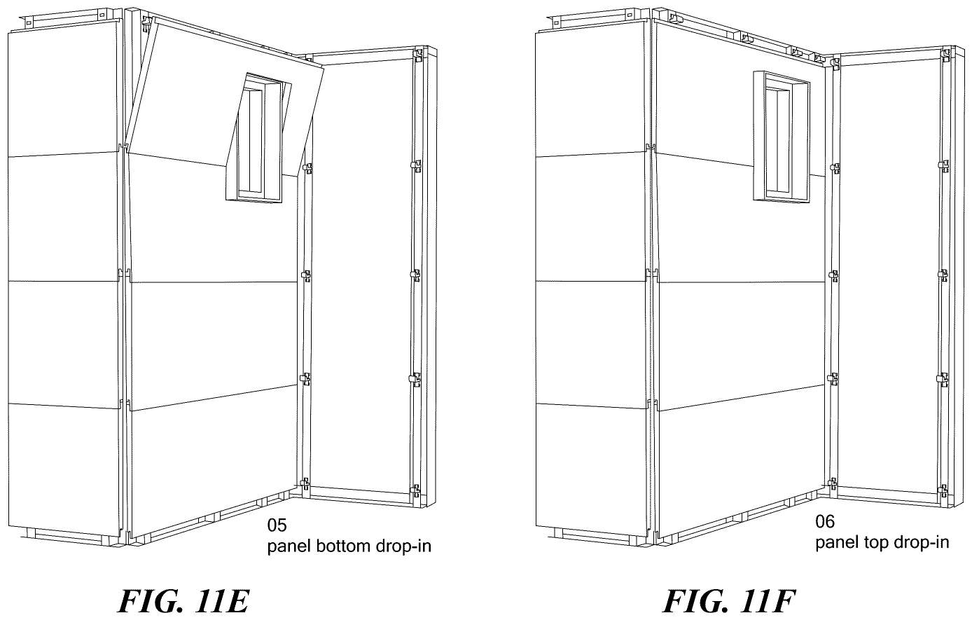

FIG. 11A shows a method of assembly and hanging of a subframe on a mockup of an existing building structure with numerous vertical tracks 10 and upper and lower subframe members connected between the spaced vertically extending Z-shaped side tracks. Successive rows of clips are then installed as shown in FIG. 11B and the building structure panels 26 are then dropped into place starting with the lowermost building structure panels seated on the lowermost row of clips and snap fit underneath the next uppermost row of clips. FIGS. 11D-11F depict additional panels being inserted and attached to the clips and to the building exterior. Thus, as can be seen the plurality of clips are configured to join two adjacent building structures and to secure the building structures to the tracks and this to the building exterior. The clips preferably include a top surface profile complementary to the building structure lower edge profile to support a building structure on the clip and the clips have a bottom surface profile complementary to the building structure upper edge profile to snap fit a building structure under the clip.

Although specific features of the invention are shown in some drawings and not in others, this is for convenience only as each feature may be combined with any or all of the other features in accordance with the invention. The words “including”, “comprising”, “having”, and “with” as used herein are to be interpreted broadly and comprehensively and are not limited to any physical interconnection. Moreover, any embodiments disclosed in the subject application are not to be taken as the only possible embodiments. Other embodiments will occur to those skilled in the art and are within the following claims.

In addition, any amendment presented during the prosecution of the patent application for this patent is not a disclaimer of any claim element presented in the application as filed: those skilled in the art cannot reasonably be expected to draft a claim that would literally encompass all possible equivalents, many equivalents will be unforeseeable at the time of the amendment and are beyond a fair interpretation of what is to be surrendered (if anything), the rationale underlying the amendment may bear no more than a tangential relation to many equivalents, and/or there are many other reasons the applicant cannot be expected to describe certain insubstantial substitutes for any claim element amended.

What is claimed is:

1. A method of coating a bio insulated panel, the method comprising:
milling one or more surfaces of a non-coated bio insulated panel resulting in surface fibers;
flame treating the milled panel surface to burn the surface fibers and heat the milled panel surface to dry the panel surface; and
coating the milled panel surface while it is dry.

2. The method of claim 1 in which milling includes sawing, drilling, and/or carving the panel.

3. The method of claim 1 in which flame treating includes using a flame at 2,000-2,500° F.

4. The method of claim 3 in which the flame treatment heats the milled surface to between 212 and 450° F.

5. The method of claim 4 in which the panel is fed past the flame at a rate of 0.25-2 feet per second.

6. The method of claim 1 in which coating includes using a two-part coating.

7. The method of claim 6 in which the coating is a polyurea coating.

8. The method of claim 6 in which the coating is applied at a pressure of 1500-3000 psi and at a temperature of 50-400° F.

9. The method of claim 1 in which coating occurs in multiple passes along the milled panel.

10. The method of claim 9 in which the first coating pass occurs within 30 minutes of flame treatment.

11. The method of claim 9 in which each pass results in a coating thickness of 5-15 mils.

12. The method of claim 11 in which coating passes continue until the coating thickness is 20-80 mils.

13. The method of claim 1 in which further including painting the coated milled surface of the bio insulated panel.

14. The method of claim 13 in which painting includes applying a paint to the coating before it fully cures to chemically integrate the paint into the coating.
